(19) United States
(12) Patent Application Publication
(10) Pub. No.: US 2014/0326148 A1
(43) Pub. Date: Nov. 6, 2014

(54) DEWATERING METHOD AND APPARATUS

(71) Applicants: Paul Austin Wootton, Pallara (AU); Martin Richard Gravett, Salisbury (AU); Janusz Krzysztof Fulara, Kallaroo (AU); Maciej Rafal Rudas, Darlington (AU); Sean Neil Sciberras, Sorrento (AU)

(72) Inventors: Paul Austin Wootton, Pallara (AU); Martin Richard Gravett, Salisbury (AU); Janusz Krzysztof Fulara, Kallaroo (AU); Maciej Rafal Rudas, Darlington (AU); Sean Neil Sciberras, Sorrento (AU)

(73) Assignee: ANAECO LIMITED, Bentley (AU)

(21) Appl. No.: 14/240,483

(22) PCT Filed: Sep. 6, 2012
(86) PCT No.: PCT/AU2012/001055

§ 371 Date: Jun. 10, 2014

(30) Foreign Application Priority Data
Sep. 8, 2011 (AU) 2011903623

(51) Int. Cl. B30B 9/12; C02F 11/12

(52) U.S. Cl. CPC B30B 9/125; C02F 11/125
USPC 100/37; 100/117; 100/50

(57) ABSTRACT

A dewatering method comprising the method steps of: (i) Conveying a material to be dewatered part way along the length of a housing (14) by way of a screw (12) that is driven by a motor (22); (ii) Monitoring the rate of change of power demand on the motor (22); (iii) Adjusting the level of backpressure to which the material to be dewatered is exposed based on the rate of change of power demand on the motor (22) as obtained under step (ii); and (iv) Forming a residual plug of dewatered material at an open end (20) of the housing (14). A dewatering apparatus (10) is also described.

### FIELD OF THE INVENTION

The present invention relates to a dewatering method and apparatus. More particularly, the dewatering method and apparatus of the present invention are intended for use in a screw press.

### BACKGROUND ART

Known screw presses utilised in the dewatering of conveyable material are typically not able to be adjusted as the dewatering process proceeds. The consequence is that the moisture content and conveyance rate of the material must be set prior to the conduct of the process. However, if the material to be conveyed varies significantly in its characteristics during the process the level of dewatering may well need to be adjusted. This may be the case in processes for the bioconversion of the organic fraction of municipal solid waste (“OFMSW”) in which the feedstock, the conveyable material, varies significantly from an essentially dry material to a sludge.

Further, known screw presses don't typically provide a pressure-tight environment. This limits the use of such apparatus in processes that require such conditions. Any device that is provided to allow operation in pressure-tight conditions will result in it not being possible to view into the device, presenting problems in terms of being able to make a visual assessment of the progress of the dewatering process.

Processes for the bioconversion of OFMSW that utilise alternating phases of anaerobic digestion and aerobic composting in a single reactor may benefit from operation under pressure-tight conditions. As noted above, such processes often require the dewatering of the organic product thereof. This is particularly the case prior to aeration and the aerobic phase. It is undesirable for an accumulation of water to occur in the aerobic phase.

In document JP 2007-237238 there is described a method for driving a screw press. The method appears to be such that a cake of material being pressed abuts and subsequently moves around a resiliently arranged ‘baffle’. The conical shaped baffle is provided about the shaft of the screw. The level of dewatering to be achieved is set by springs that govern the movement of the baffle. Further, a conical shaft is employed that also participates in the dewatering process. This method does not allow for materials in which there is significant variation in its characteristics. The screw also extends the full length of the screw press.

International Patent Application PCT/EP2006/067921 describes a screw press that is provided with a pivotally mounted constriction means at its discharge mouth, the constriction means being driven by way of an irreversible screw. A pressure sensor is provided on the constriction means that provides feedback regarding the pressure exerted by the material being conveyed to a microprocessor and by which the current draw of a motor driving the screw of the screw press is also monitored. If the current draw of the motor exceeds a predetermined value the constriction means may be opened further. In order to prevent the formation of residual plugs of material within the discharge mouth of the screw press the rotating screw provided therein terminates very close to the discharge mouth.

In document JP 2001-038490 there is described a screw press hydroextractor that comprises a screw that conveys a sludge material along a cyclindrical screen whilst backpressure is applied by a back pressure plate provided at a discharge port for ‘dewatering cake’. An ‘automatic open/close’ mechanism is described by which discharge of the ‘sludge cake’ is promoted. The back pressure plate is driven by a screw drive, providing what appears to be very direct and rigid positioning of that plate relative to a discharge port for the ‘sludge cake’. Further, the screw is described as extending through the length of the screen to the discharge port.

In document 2000-288596 there is shown a continuous pressure dehydrator that comprises a front concentration zone, a flexible connection pipe and an inclined filter. Both the concentration zone and the filter are provided with screens therein. A sludge to be dehydrated is conveyed by a screw through the concentration zone but not through the connection pipe and filter due, at least in part, to the inclination thereof. The angle of inclination is adjustable to cater for sludges of different filterability. Movement of sludge through these portions is achieved by way of pressure from the material being conveyed through the concentration zone. The filter is provided with a backpressure adjusting plate at a discharge port thereof, the pressure exerted by the plate being adjusted by the control signal of a controller. A torque detector and comparator are provided for comparing detected load current with a preset torque value. An irrigation arrangement for the filters is also described. The dehydrator described in this document provides a very complicated attempt to solve the problem of dewatering, particularly in terms of the need for adjustable inclination of the filter.

In document 06-000697 there is shown a discharge regulator for a separator and dehydrator. In many respects this arrangement is similar to that of JP 2007-237238 described hereinabove. A compression ring, of conical shape, is moveable about the shaft of the conveyor and within a drain hole. Again, the shaft of the conveyor extends the full length of the dehydrator.

The dewatering method and apparatus of the present invention have as one object thereto to overcome substantially the abovementioned problems of the prior art, or to at least provide a useful alternative thereto.

The following discussion of the background art is intended to facilitate an understanding of the present invention only. The discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a dewatering method comprising the method steps of:
(i) Conveying a material to be dewatered part way along the length of a housing by way of a screw that is driven by a motor;
(ii) Monitoring the rate of change of power demand on the motor;
(iii) Adjusting the level of backpressure to which the material to be dewatered is exposed based on the rate of change of power demand on the motor as obtained under step (ii); and
(iv) Forming a residual plug of dewatered material at an outlet of the housing.

Preferably, the screw has provided thereabout, over at least a portion thereof, a screen, whereby liquid from the material being conveyed may pass therethrough.

Still preferably, the housing is pressure-tight.

In one form of the present invention the backpressure is provided by way of a backpressure means provided at an end of the screw conveyor housing. The backpressure means is adjustable through a range of positions in which the level of backpressure exerted on the material being conveyed varies. The backpressure means is preferably provided in the form of an adjustable flap.

Preferably, the adjustable flap is pivotally mounted at an otherwise open end of the housing. The pivotal mounting is preferably provided at a top of the open end of the housing.

The movement of the adjustable flap is preferably driven by a ram. The ram may be provided in the form of a pneumatic ram. Preferably, the ram is driven through an intermediate linking member.

Preferably, the position of the adjustable flap relative to the open end of the housing may be detected. This detection is preferably achieved by way of sensors and/or transducers.

Preferably, the material is conveyed by the screw to a point in the housing just short of the outlet, thereby facilitating the formation of the residual plug. The point to which the material is conveyed is preferably between 0.5 and 1.25 times the diameter of the screw short of the housing outlet.

Still preferably, the residual plug may be relaxed through a reversal of the screw and a closing of the adjustable flap.

In accordance with the present invention there is further provided a dewatering apparatus comprising a screw, a housing, a screen and an adjustable backpressure means, wherein the housing is provided about the screen, which in turn is provided about at least a portion of the screw, the screw being arranged so as to convey material toward an open end of the housing but just short thereof, at which open end is provided the backpressure means.

Preferably, adjustment of the backpressure means varies the level of dewatering of the material conveyed through the dewatering apparatus.

The dewatering apparatus further comprises a motor that is arranged to drive the screw conveyor. The motor preferably has provided in relation thereto a monitoring device that allows the rate of change of power demand thereby to be monitored.

Preferably, the housing is pressure-tight.

The backpressure means is preferably adjustable through a range of positions in which the level of backpressure exerted on the material being conveyed varies. The backpressure means is preferably provided in the form of an adjustable flap.

Preferably, the adjustable flap is pivotally mounted at the open end of the housing. The pivotal mounting is preferably provided at a top of the open end of the housing.

The movement of the adjustable flap is preferably driven by a ram. The ram may be provided in the form of a pneumatic ram. Preferably, the ram is driven through an intermediate linking member. The dewatering apparatus preferably further comprises sensors and/or transducers by which detection of the position of the adjustable flap relative to the open end of the housing can be achieved.

In one form of the present invention the housing is provided in first and second sections. The first section of housing comprises a material inlet and a first and second end, the material inlet being provided between the first and second ends. A mounting for the screw motor is provided at the first end. Further, the material inlet is provided adjacent to the first end of the first section of the housing.

The second end of the first section of the housing is arranged so as to connect with a first end of the second section of the housing. The screw extends from the first section of the housing into the second section of the housing.

Preferably, a screen is provided within the second section of the housing, into which the material being conveyed is directed. The screw preferably terminates short of the open end of the housing.

Preferably, the screw extends to a point in the housing just short of the outlet, thereby facilitating the formation of the residual plug. The point to which the screw extends is preferably between 0.5 and 1.25 times the diameter of the screw short of the housing outlet.

Still preferably, reversal of the screw and closing of the adjustable flap facilitates the relaxation of the residual plug.

Still preferably, a liquid outlet is provided in the second section of the housing. The liquid outlet is preferably oriented to catch liquid flow as it flows under gravity rearwardly with respect to the dewatering apparatus, resulting from the dewatering apparatus being provided such that the material is conveyed up an incline.

An outlet housing is preferably provided immediately after the open end of the housing, comprising in turn a material outlet by which the dewatered material may pass from the dewatering apparatus.

### BRIEF DESCRIPTION OF THE DRAWINGS

The dewatering method and apparatus of the present invention will now be described, by way of example only, with reference to one embodiment thereof and the accompanying drawings, in which:

FIG. 1 is a lower perspective view of a dewatering apparatus in accordance with the present invention;

FIG. 2 is an upper perspective view of the dewatering apparatus of FIG. 1;

FIG. 3 is top plan view of the dewatering apparatus of FIG. 1;

FIG. 4 is a side elevational view of the dewatering apparatus of FIG. 1;

FIG. 5 is a cross sectional end view of the dewatering apparatus of FIG. 1, showing an outlet housing in section and an adjustable flap;

FIG. 6 is a cross sectional side view of a second section of the housing, and the outlet housing, of the dewatering apparatus of FIG. 1, showing the adjustable flap and material outlet, together with a ram and intermediate linking member driving the adjustable flap;

FIG. 7 is a cross sectional side view of the dewatering apparatus of FIG. 1, showing the screw provided within the housing and the termination of the screw some distance short of the open end thereof; and

FIG. 8 is a cross sectional side view of a portion of the join between first and second sections of the housing, showing the screen provided in the second section.

### BEST MODE(S) FOR CARRYING OUT THE INVENTION

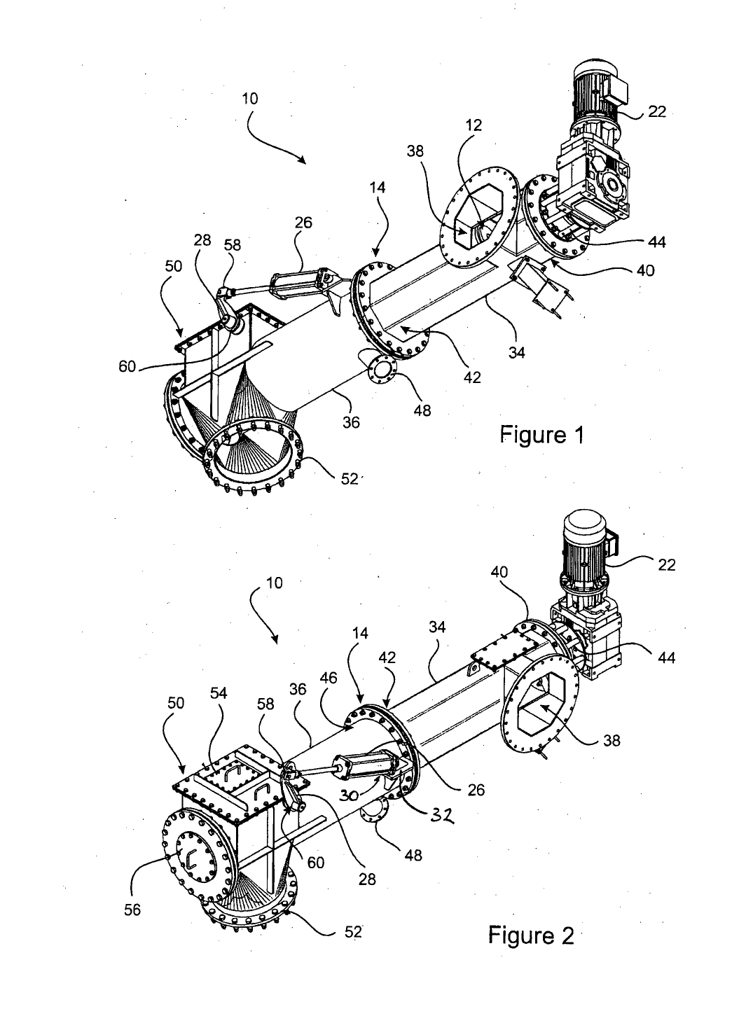

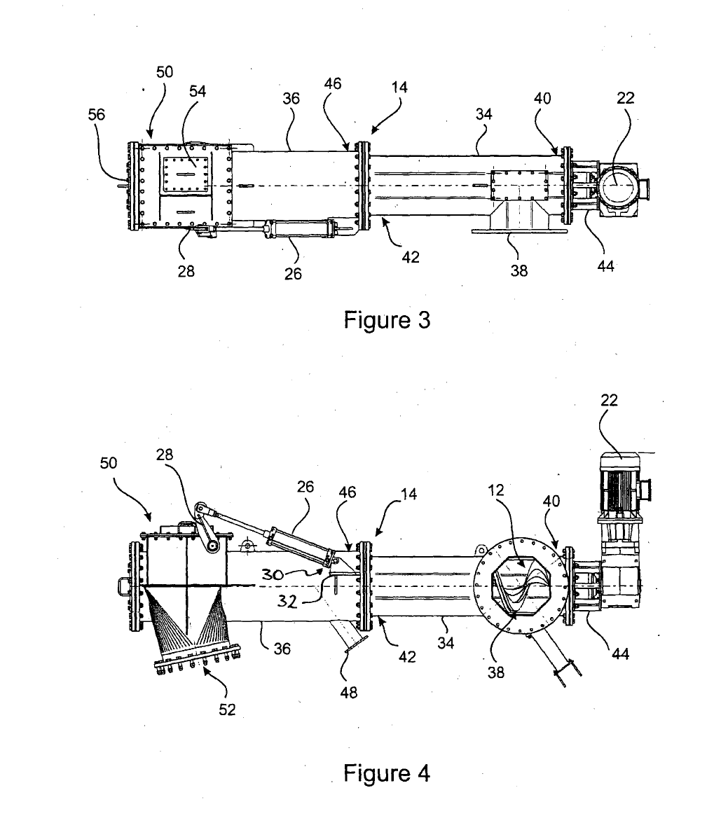

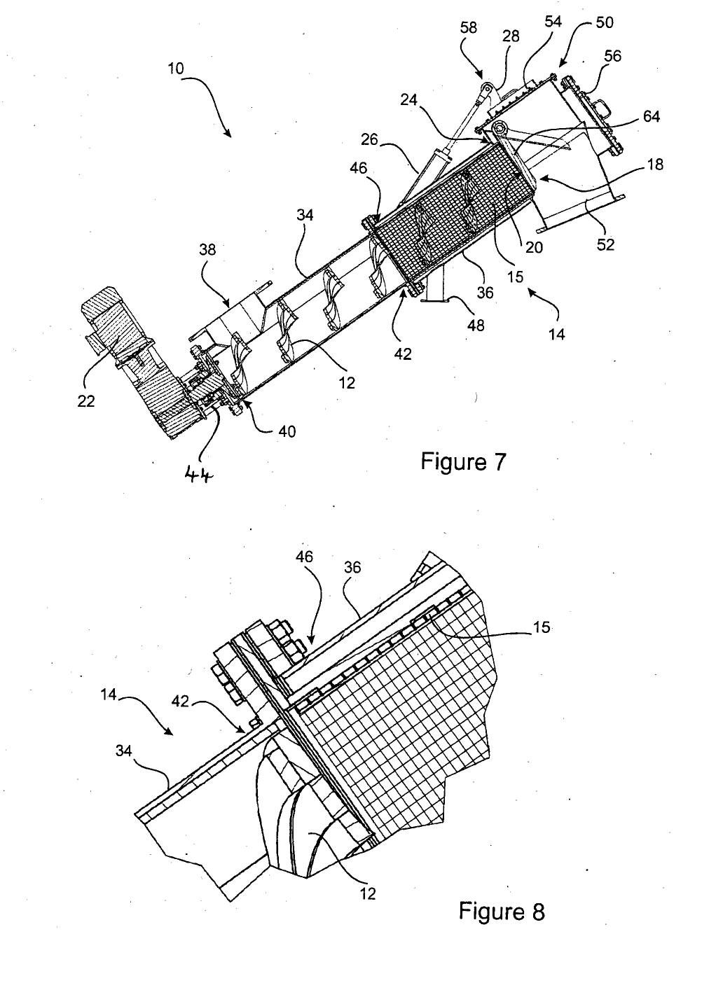

In FIGS. 1 to 8 there is shown a dewatering apparatus 10 in accordance with the present invention. The dewatering apparatus 10 comprises a screw 12, a housing 14, a screen 15 and an adjustable backpressure means, for example an adjustable flap 18, best seen in FIGS. 6 and 7. The housing 14 is provided about the screen, which in turn is provided about at least a portion of the screw 12, the screw 12 being arranged so as to convey material (not shown) to an open end 20 of the housing 14, at which open end 20 is provided the adjustable flap 18.

The adjustment of the adjustable flap 18 varies the level of dewatering of the material conveyed through the dewatering apparatus 10.

The dewatering apparatus 10 further comprises a motor 22 that is arranged to drive the screw 12. The motor 22 has provided in relation thereto a monitoring device (not shown) that allows the rate of change of power demand thereby to be monitored.

The housing 14 is provided so as to be substantially pressure-tight. This is expected to facilitate the use of the apparatus 10 in circumstances that require dewatering in a pressure-tight environment.

The adjustable flap 18 is pivotally mounted at a top 24 of the open end 20 of the housing 14. The movement of the adjustable flap 18 is driven by a ram means, for example a pneumatic ram 26, through an intermediate linking member 28. A base 30 of the ram 28 is mounted on a mount 32 provided on the housing 14.

The housing 14 is provided in first and second sections, 34 and 36 respectively. The first section 34 of the housing 14 comprises a material inlet 38 and a first end 40 and a second end 42, the material inlet 38 being provided between the first end 40 and second end 42. A mounting 44 for the screw motor 22 is provided at the first end 40. Further, the material inlet 38 is provided adjacent the first end 40 of the first section 34 of the housing 14.

The second end 42 of the first section 34 of the housing 14 is arranged so as to connect with a first end 46 of the second section 36 of the housing 14. The screw 12 extends from the first section 34 of the housing 14 into the second section 36 of the housing 14.

The screen 15 is provided within the second section 36 of the housing 14, into which the material being conveyed is directed, as is best seen in FIGS. 7 and 8. The provision of a length of screen along only a portion of the length over which the material is conveyed is intended to reduce friction of the material, and power consumption, relative to screw presses in which a full length screen is provided. The screw 12 terminates short of the open end 20 of the housing 14, as seen best in FIG. 7. Depending upon the specific application the distance between the end of screw 12 and the open end 20 of the housing 14 is between about 0.5 to 1.25 times the diameter of the screw 12.

A liquid outlet 48 is provided in the second section 36 of the housing 14. The liquid outlet 48 is oriented to catch liquid flow as it flows under gravity rearwardly with respect to the dewatering apparatus 10, resulting from the dewatering apparatus 10 being provided such that the material is conveyed up an incline, being between about 5 to 50°, for example about 36°, to the horizontal.

An outlet housing 50 is provided immediately after the open end 20 of the housing 14, comprising in turn a material outlet 52 by which the dewatered material passes from the dewatering apparatus 10. A first inspection hatch 54 is provided in an upper surface of the outlet housing 50 and a second inspection hatch 56 is provided in an end surface of the outlet housing 50.

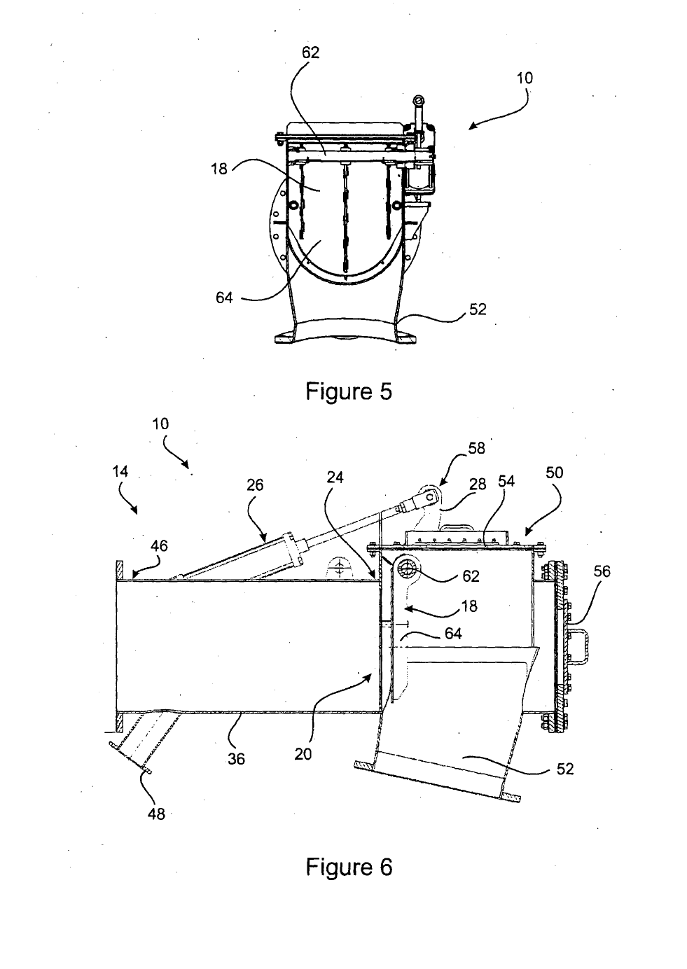

The ram 26 is pivotally connected to the intermediate linking member 28 at a first end 58 thereof. At a second end 60 of the intermediate linking member 28 there is provided a rigid connection to an elongate rod 62 rotatably mounted through the outlet housing 50. The elongate rod 62 forms part of the adjustable flap 18. The elongate rod is rigidly attached to a flap panel 64 that is proportioned to be of substantially the same size and shape as that of the open end 20 of the housing 14, as is best seen in FIGS. 5 and 6.

In use, a user (not shown) is able to monitor the performance of the apparatus 10 and the method of the present invention by way of the rate of change in current draw by the motor 22 driving the screw 12. The rate of change in current draw is informative of the composition and feed rate of the material being conveyed and is used to position the adjustable flap 18, in accordance with parameters set by the user and entered into some form of programmable logic controller (“PLC”) prior to or during operation. For example, if the material being conveyed is being conveyed too easily, that is with too little current draw, the adjustable flap 18 is adjusted so as to retain the conveyed material within the housing 14 for a longer period. In the above manner the dewatering effort, the efficiency and material consistency can be controlled through use of the apparatus and method of the present invention.

It is envisaged that sensors, or either linear or angular transducers may be provided to detect the position of the flap panel 64 relative to the open end 20 of the housing 14. This information is fed back to the PLC described above. The level of back pressure able to be borne by the flap panel 64 may be pre-set according to different angular positions of the flap panel 64 relative to the open end 20 of the housing 14. This provides for good control of dewatering together with variation in the feed rate of material.

The PLC further provides for the rotation of the screw 12 in a reverse direction. The reversal of the rotation of the screw 12 in conjunction with the gradual closing of the adjustable flap 18 facilitates the ‘relaxation’ of any residual plug of material formed in the housing 14 adjacent its open end 20. This results is minimisation of the plug size and its degree of consolidation. The relaxation of the plug is convenient in terms of preparation for future use of the dewatering apparatus 10. A smaller and softer plug assists with the control of the operation of the dewatering apparatus 10.

The residual plug is understood to provide a barrier/spacer between the adjustable flap 18 and incoming material (to be dewatered) at the end of screw 12. It facilitates the initial and the most effective material consolidation and dewatering taking place within the screen 15. With no plug, some of the material consolidation takes place at the adjustable flap 18, resulting .in a portion of the just separated water being discharged to the open end 20, where it mixes with material just dewatered.

It is further envisaged that the use of a pneumatic ram 26 as opposed to a screw actuator or similar mechanical arrangement provides for some flexibility within the adjustable flap 18. Screw actuators are very rigid in terms of the position that is assumed, and anything connected thereto is held very rigidly in that position.

It is envisaged that the screw 12 may be provided in either a shafted or shaftless form. The screw 12 may further be double flighted at its end adjacent the open end 20 of the housing 14.

The formation of a residual plug in the material being conveyed is encouraged by the manner in which the screw 12 terminates short of the open end 20 of the housing 14. As noted above, depending upon the specific application the distance between the screw 12 and the open end 20 of the housing 14 is between about 0.5 to 1.25 times the diameter of the screw 12.

It is further envisaged that the apparatus 10 and method of the present invention have particular application in the bioconversion of organic material, such as OFMSW. Processes for the bioconversion of OFMSW that utilise alternating phases of anaerobic digestion and aerobic composting in a single reactor may benefit from operation under pressure-tight conditions. Such processes often require the dewatering of the organic product thereof. This is particularly the case prior to aeration and the aerobic phase. It is undesirable for an accumulation of water to occur in the aerobic phase.

Accordingly, it is envisaged that the organic material being conveyed in such an arrangement will be dewatered to about 50% water content.

The abovementioned processes for the bioconversion of organic material are most effectively operated under pressure-tight conditions, for reasons described previously. The dewatering apparatus 10 of the present invention is constructed in such manner that it may operate under pressure tight conditions. As the pressure-tight conditions mitigate against an ability to see into the outlet housing 50 and inspect the quality or characteristics of the conveyed material, it is important to have the feedback of the current draw or load on the motor 22 so that adjustments needed may be identified and acted on by a repositioning of the backpressure means, the adjustable flap 18.

It is envisaged that it is a combination of the provision of a resilient plug, moving along the screen with frictional resistance from the screen and controlled backpressure of the adjustable flap that results in the effectiveness of the method and apparatus of the present invention.

Modifications and variations such as would be apparent to the skilled addressee are considered to fall within the scope of the present invention.

1. A dewatering method comprising the method steps of:
(i) Conveying a material to be dewatered part way along the length of a housing by way of a screw that is driven by a motor;
(ii) Monitoring the rate of change of power demand on the motor;
(iii) Adjusting the level of backpressure to which the material to be dewatered is exposed based on the rate of change of power demand on the motor as obtained under step (ii); and
(iv) Forming a residual plug of dewatered material at an open end of the housing.

2. A method according to claim 1, wherein the screw has provided thereabout, over at least a portion thereof, a screen, whereby liquid from the material being conveyed may pass therethrough.

3. A method according to claim 1, wherein the housing is pressure-tight.

4. A method according to claim 1, wherein the backpressure is provided by way of a backpressure means provided at an end of the screw conveyor housing.

5. A method according to claim 1, wherein the backpressure means is adjustable through a range of positions in which the level of backpressure exerted on the material being conveyed varies.

6. A method according to claim 4, wherein the backpressure means is provided in the form of an adjustable flap.

7. A method according claim 6, wherein the adjustable flap is pivotally mounted at the otherwise open end of the housing.

8. A method according to claim 7, wherein the pivotal mounting is provided at a top of the open end of the housing.

9. A method according to claim 6, wherein the movement of the adjustable flap is driven by a ram.

10. A method according to claim 9, wherein the ram is provided in the form of a pneumatic ram.

11. A method according to claim 9, wherein the ram is driven through an intermediate linking member.

12. A method according to claim 6, wherein the position of the adjustable flap relative to the open end of the housing may be detected.

13. A method according to claim 12, wherein detection is achieved by way of sensors and/or transducers.

14. A method according to claim 1, wherein the material is conveyed by the screw to a point in the housing just short of the outlet, thereby facilitating the formation of the residual plug.

15. A method according to claim 14, wherein the point to which the material is conveyed is between 0.5 and 1.25 times the diameter of the screw short of the housing outlet.

16. A method according to claim 14, wherein the residual plug may be relaxed through a reversal of the screw and a closing of the adjustable flap.

17. A dewatering apparatus comprising a screw, a housing, a screen and an adjustable backpressure means, wherein the housing is provided about the screen, which in turn is provided about at least a portion of the screw, the screw being arranged so as to convey material toward an open end of the housing but just short thereof, at which open end is provided the backpressure means.

18. Apparatus according to claim 17, wherein adjustment of the backpressure means varies the level of dewatering of the material conveyed through the dewatering apparatus.

19. Apparatus according to claim 17, wherein the dewatering apparatus further comprises a motor that is arranged to drive the screw.

20. Apparatus according to claim 19, wherein the motor has provided in relation thereto a monitoring device that allows the rate of change of power demand thereby to be monitored.

21. Apparatus according to claim 17, wherein the housing is pressure-tight.

22. Apparatus according to claim 17, wherein the backpressure means is adjustable through a range of positions in which the level of backpressure exerted on the material being conveyed varies.

23. Apparatus according to claim 17, wherein the backpressure means is provided in the form of an adjustable flap.

24. Apparatus according to claim 23, wherein the adjustable flap is pivotally mounted at the open end of the housing.

25. Apparatus according to claim 24, wherein the pivotal mounting is provided at a top of the open end of the housing.

26. Apparatus according to claim 23, wherein the movement of the adjustable flap is driven by a ram.

27. Apparatus according to claim 26, wherein the ram is provided in the form of a pneumatic ram.

28. Apparatus according to claim 26, wherein the ram is driven through an intermediate linking member.

29. Apparatus according to claim 17, wherein the dewatering apparatus further comprises sensors and/or transducers by which detection of the position of the adjustable flap relative to the open end of the housing can be achieved.

30. Apparatus according to claim 17, wherein the housing is provided in first and second sections.

31. Apparatus according to claim 30, wherein the first section of housing comprises a material inlet and a first and second end, the material inlet being provided between the first and second ends.

32. Apparatus according to claim 31, wherein a mounting for the screw motor is provided at the first end.

33. Apparatus according to claim 31, wherein the material inlet is provided adjacent the first end of the first section of the housing.

34. Apparatus according to claim 31, wherein the second end of the first section of the housing is arranged so as to connect with a first end of the second section of the housing.

35. Apparatus according to claim 30, wherein the screw extends from the first section of the housing into the second section of the housing.

36. Apparatus according to claim 30, wherein a screen is provided within the second section of the housing, into which the material being conveyed is directed.

37. Apparatus according to claim 17, wherein the screw extends to a point in the housing just short of the outlet, thereby facilitating the formation of a residual plug of material.

38. Apparatus according to claim 37, wherein the point to which the screw extends is between 0.5 and 1.25 times the diameter of the screw short of the housing outlet.

39. Apparatus according to claim 37, wherein reversal of the screw and closing of the adjustable flap facilitates the relaxation of the residual plug.

40. Apparatus according to claim 30, wherein a liquid outlet is provided in the second section of the housing.

41. Apparatus according to claim 40, wherein the liquid outlet is oriented to catch liquid flow as it flows under gravity rearwardly with respect to the dewatering apparatus, resulting from the dewatering apparatus being provided such that the material is conveyed up an incline.

42. Apparatus according to claim 17, wherein an outlet housing is provided immediately after the open end of the housing, comprising in turn a material outlet by which the dewatered material may pass from the dewatering apparatus.

43. (canceled)

44. (canceled)
